(19) United States
(12) Patent Application Publication
(10) Pub. No.: US 2026/0054184 A1
(43) Pub. Date: Feb. 26, 2026

(54) ANIMATION DISPLAY METHOD AND APPARATUS, DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventor: Minke ZHOU, Shenzhen (CN)

(21) Appl. No.: 19/374,591

(22) Filed: Oct. 30, 2025

Related U.S. Application Data
(63) Continuation of application No. PCT/CN2024/137375, filed on Dec. 6, 2024.

(30) Foreign Application Priority Data
Jan. 9, 2024 (CN) 202410033051.8

(51) Int. Cl. A63F 13/837; A63F 13/2145; A63F 13/537

(52) U.S. Cl. CPC A63F 13/837; A63F 13/2145; A63F 13/537

(57) ABSTRACT

An animation display method performed by a computer device includes displaying a game picture that includes a virtual object located in a virtual environment. The virtual object holds a virtual prop, the virtual object is in a target state, and the target state is one of a stationary state, a running state, or a walking state. The method further includes obtaining an animation of the virtual object in response to a trigger operation of a shooting function and displaying the animation. In, the animation, the virtual object performs a shooting operation through the virtual prop when being in the target state.

### CROSS-REFERENCE TO RELATED APPLICATIONS

This application is a continuation of International Application No. PCT/CN2024/137375, filed on Dec. 6, 2024, which claims priority to Chinese Patent Application No. 202410033051.8, filed on Jan. 9, 2024 and entitled “ANIMATION DISPLAY METHOD AND APPARATUS, DEVICE, AND COMPUTER-READABLE STORAGE MEDIUM,” the entire contents of both of which are incorporated herein by reference.

### FIELD OF THE TECHNOLOGY

Embodiments of this application relate to the field of computer technologies, and in particular, to an animation display method and apparatus, a device, and a computer-readable storage medium.

### BACKGROUND OF THE DISCLOSURE

With the continuous development of computer technologies, gaming technologies are also continuously developed. In some shooting games, a player may control a virtual object to perform a shooting operation on a virtual prop in a virtual scene of a game battle.

### SUMMARY

In accordance with the disclosure, there is provided an animation display method performed by a computer device and including displaying a game picture that includes a virtual object located in a virtual environment. The virtual object holds a virtual prop, the virtual object is in a target state, and the target state is one of a stationary state, a running state, or a walking state. The method further includes obtaining an animation of the virtual object in response to a trigger operation of a shooting function and displaying the animation. In the animation, the virtual object performs a shooting operation through the virtual prop when being in the target state.

Also in accordance with the disclosure, there is provided a computer device including a processor, and a memory storing at least one program code that, when executed by the processor, causes the computer device to display a game picture that includes a virtual object located in a virtual environment. The virtual object holds a virtual prop, the virtual object is in a target state, and the target state is one of a stationary state, a running state, or a walking state. The at least one program code, when executed by the processor, further causes the computer device to obtain an animation of the virtual object in response to a trigger operation of a shooting function and display the animation. In the animation, the virtual object performs a shooting operation through the virtual prop when being in the target state.

Also in accordance with the disclosure, there is provided a non-transitory computer-readable storage medium storing at least one program code that, when executed by a processor, causes a computer including the processor to display a game picture that includes a virtual object located in a virtual environment. The virtual object holds a virtual prop, the virtual object is in a target state, and the target state is one of a stationary state, a running state, or a walking state. The at least one program code, when executed by the processor, further causes the computer device to obtain an animation of the virtual object in response to a trigger operation of a shooting function and display the animation. In the animation, the virtual object performs a shooting operation through the virtual prop when being in the target state.

### BRIEF DESCRIPTION OF THE DRAWINGS

FIG. 1 is a schematic diagram showing an implementation environment of an animation display method according to an embodiment of this application.

FIG. 2 is a flowchart of an animation display method according to an embodiment of this application;

FIG. 3 is a schematic diagram showing a game picture according to an embodiment of this application.

FIG. 4 is a schematic diagram showing a backpack page according to an embodiment of this application.

FIG. 5 is a schematic diagram showing another game picture according to an embodiment of this application.

FIG. 6 is a schematic diagram showing an animation frame of a whole-body animation in which a virtual object according to an embodiment of this application performs a hip-fire operation through a virtual prop in a state.

FIG. 7 is a schematic diagram showing another game picture according to an embodiment of this application.

FIG. 8 is a schematic diagram showing a game picture according to an embodiment of this application.

FIG. 9 is a schematic diagram showing a game picture according to an embodiment of this application.

FIG. 10 is a schematic diagram showing a game picture according to an embodiment of this application.

FIG. 11 is a schematic diagram showing a game picture according to an embodiment of this application.

FIG. 12 is a schematic diagram showing a game picture according to an embodiment of this application.

FIG. 13 is a schematic diagram showing a game picture according to an embodiment of this application.

FIG. 14 is a schematic diagram showing a game picture according to an embodiment of this application.

FIG. 15 is a flowchart of an animation display method according to an embodiment of this application.

FIG. 16 is a flowchart of an animation display method according to an embodiment of this application.

FIG. 17 is a schematic diagram showing a configuration interface according to an embodiment of this application.

FIG. 18 is a schematic diagram showing a configuration interface according to an embodiment of this application.

FIG. 19 is a schematic diagram showing a configuration interface according to an embodiment of this application.

FIG. 20 is a schematic structural diagram of an animation display apparatus according to an embodiment of this application.

FIG. 21 is a schematic structural diagram of a terminal device according to an embodiment of this application.

FIG. 22 is a schematic structural diagram of a server according to an embodiment of this application.

### DESCRIPTION OF EMBODIMENTS

Terms “first,” “second,” and the like in this application are configured for distinguishing between similar objects, and are not necessarily configured for describing a specific order or sequence. Terms used in this way are exchangeable in a proper case, so that the embodiments of this application described herein can be implemented in another order other than those shown or described herein. The implementations described in the following exemplary embodiments do not represent all implementations consistent with this application. On the contrary, the implementations are merely examples of an apparatus and a method which are consistent with some aspects of this application described in detail in the attached claims.

In related technologies, an upper body shooting animation and a lower body shooting animation corresponding to a virtual object and a virtual prop are obtained in response to a trigger operation of a shooting function. The upper body shooting animation and the lower body shooting animation are displayed, to achieve the purpose of the virtual object performing the shooting operation on the virtual prop.

However, in the foregoing animation display method, the upper body shooting animation and the lower body shooting animation need to be respectively displayed, resulting in poor continuity of animation display, and then leading to a poor shooting effect of the virtual object and a low usage rate of the shooting function of the virtual object, affecting the interaction rate of a game.

First, abbreviations and key terms involved in the embodiments of this application are defined.

Virtual environment: refers to an environment provided (or displayed) when an application is run on a terminal device, and the virtual environment refers to the environment created for a virtual object to perform an activity. The virtual environment may be a two-dimensional virtual environment, a 2.5-dimensional virtual environment, a three-dimensional virtual environment, or the like. The virtual environment may be a simulated environment of the real world, or may be a semi-simulated environment of the real world, and may further be a purely fictitious environment. For example, the virtual environment involved in this embodiment of this application is a three-dimensional virtual environment.

Virtual object: refers to a movable object in the virtual environment. The movable object may be a virtual person, a virtual animal, an animation person, and the like. A player may manipulate the virtual object through a peripheral component or by tapping a touch display screen. Each virtual object has a shape and a volume in the virtual environment, and occupies a part of space in the virtual environment. For example, when the virtual environment is the three-dimensional virtual environment, the virtual object is a three-dimensional model created based on an animation skeleton technology.

Mobile terminal: includes but not limited to all handheld portable game devices herein, such as a mobile phone.

Shooting game: includes all games in which firearms are configured for long-range attack, including but not limited to first-person shooting games and third-person shooting games.

Whole-body animation: one of animation production manners. In a shooting game, a behavior of a virtual object in the game is presented by an animation. The animation may be produced separately as an upper body and a lower body and then spliced together for playback, or may be produced as a whole body and then directly played. A difference between the whole-body animation and a half-body animation lies in whether the animation needs to be disassembled into two animations for splicing and playback. In an embodiment of this application, the whole-body animation includes an animation of all parts of a whole body of the virtual object. With a scenario in which a virtual object performs shooting through a virtual prop is used as an example, a whole-body animation of the virtual object can display all parts of the whole body of the virtual object when the virtual object performs shooting through the virtual prop.

Animation blending: a method of using animations, which means that a plurality of animations are played on the same target body, and may occur on different parts. For example, different animations are played on an upper body and a lower body of the body of a virtual object. The animation blending may also occur on the same part. For example, two animations are simultaneously added to an upper body of the virtual object, and are played based on weights.

Hip firing: shooting directly through a default crosshair of a virtual prop without using a virtual sight. Such a shooting manner can fire instantly, eliminating the need to aim, and can directly and accurately strike the enemy, which is suitable for a close-range combat and can fire faster.

Shoulder firing: shooting through a virtual sight, or placing a virtual prop against a shoulder of a virtual object and shooting by starting the virtual sight or an iron sight. Such a shooting manner is suitable for medium and long-range combats, which can improve shooting precision. A player may use a high power lens to observe enemies in the distance.

An example frame: frame may be commonly understood as a still picture. An animation is often composed of a plurality of frames, thereby achieving a moving effect.

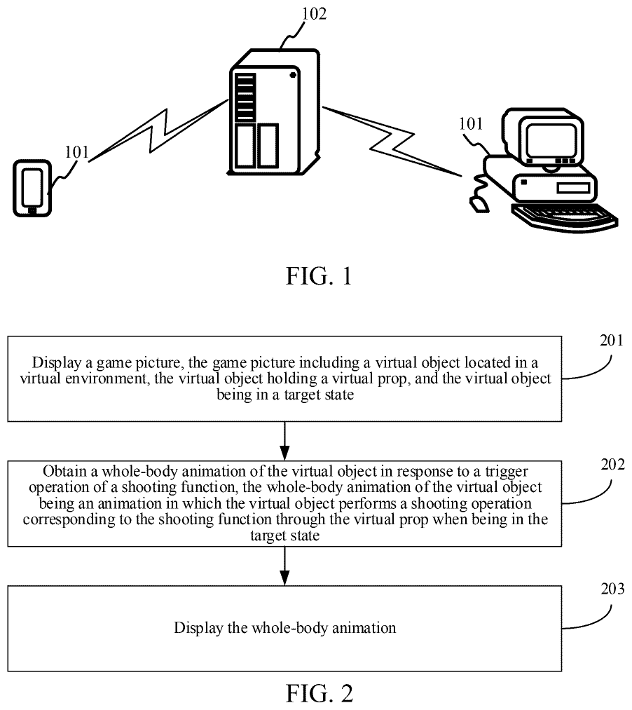

FIG. 1 is a schematic diagram showing an implementation environment of an animation display method according to an embodiment of this application. As shown in FIG. 1, the implementation environment includes a terminal device 101 and a server 102.

A game client that can provide a virtual environment is installed and run in the terminal device 101. The terminal device 101 is configured to perform the animation display method according to this embodiment of this application.

Exemplarily, the game client that can provide a virtual environment may be a third-person shooting (TPS) game, a first-person shooting (FPS) game, a multiplayer online battle arena (MOBA) game, a multiplayer shooting survival game, a massive multiplayer online role-playing game (MMO), an action role playing game (ARPG), a virtual reality (VR) client, an augmented reality (AR) client, a three-dimensional map program, a map simulation program, a social client, or an interactive entertainment client.

The server 102 is configured to provide a background service for the game client installed in the terminal device 101 that can provide the virtual environment. In a possible implementation, the server 102 is in charge of primary computing work, and the terminal device 101 is in charge of secondary computing work. Alternatively, the server 102 is in charge of the secondary computing work, and the terminal device 101 is in charge of the primary computing work. Alternatively, collaborative computing is performed between the terminal device 101 and the server 102 through a distributed computing architecture.

In some embodiments, the terminal device 101 is any electronic device product that may perform human-computer interaction with a user in one or more manners such as a keyboard, a touch pad, a remote control, voice interaction, or a handwriting device, For example, the terminal device 101 may be a smart phone, a tablet computer, a notebook computer, a desktop computer, a smart speaker, a smart watch, a personal computer (PC), a mobile phone, a personal digital assistant (PDA), a wearable device, a pocket PC (PPC), a smart car infotainment system, or a smart television.

The terminal device 101 may generally refer to one of a plurality of terminal devices. In this embodiment, only the terminal device 101 is used as an example for description. A person skilled in the art may understand that more or fewer terminal devices 101 may be provided. For example, only one foregoing terminal device 101, or dozens or hundreds of foregoing terminal devices 101, or more terminal devices may be arranged. A quantity and device types of the terminal devices 101 are not limited in the embodiments of this application.

The server 102 is one server, a server cluster formed by a plurality of servers, or any one of a cloud computing platform or a virtualization center. This is not limited in the embodiments of this application. The server 102 and the terminal device 101 are communicatively connected directly or indirectly through wired communication or wireless communication. The server 102 has a data receiving function, a data processing function, and a data transmitting function. Certainly, the server 102 may further have another function, which is not limited in the embodiments of this application.

A person skilled in the art is to understand that the foregoing terminal device 101 and the server 102 are only examples, and other existing or future terminal devices or servers, if applicable to this application, that may appear are also to be included in the protection scope of this application, and are incorporated herein by reference.

An embodiment of this application provides an animation display method. The method may be applied to the implementation environment shown in the foregoing FIG. 1. A flowchart of an animation display method according to an embodiment of this application shown in FIG. 2 is used as an example. The method may be performed by the terminal device 101 in FIG. 1. As shown in FIG. 2, the method includes the following operation 201 to operation 203.

In operation 201, a game picture is displayed, the game picture including a virtual object located in a virtual environment, with the virtual object holding a virtual prop and being in a target state.

In an exemplary embodiment of this application, a game client that can provide a virtual environment is installed and run in the terminal device. The game client may be a game client of any type, which is not limited in this embodiment of this application. The game client may be a game client from a first person perspective, or may be a game client from a third person perspective. The game client may be a frame synchronization-based game client. In other words, the animation display method provided in this embodiment of this application may be applied to the frame synchronization-based game client.

A display interface of the terminal device has relevant information of the game client displayed thereon. The relevant information of the game client may be an icon of the game client, or may be a name of the game client, and may further be other information that can uniquely represent the game client. This is not limited in this embodiment of this application. When a user wants to run the game client, the user selects the relevant information of the game client. That the user selects the relevant information of the game client may mean that the user clicks/taps relevant information of the game client, or may mean that the relevant information of the game client is selected in another manner. This is not limited in this embodiment of this application.

The user selects the relevant information of the game client, and the terminal device receives a trigger operation for the relevant information of the game client, and displays a game picture in response to the trigger operation for the relevant information of the game client. The game picture includes the virtual object located in the virtual environment, and the virtual object is in the target state.

The virtual object is an object controlled by the user in the game client, and the target state is any one of a stationary state, a running state, and a walking state. That the virtual object is in the target state means that the virtual object is in the stationary state, or that the virtual object is in the running state, or that the virtual object is in the walking state. This is not limited in this embodiment of this application.

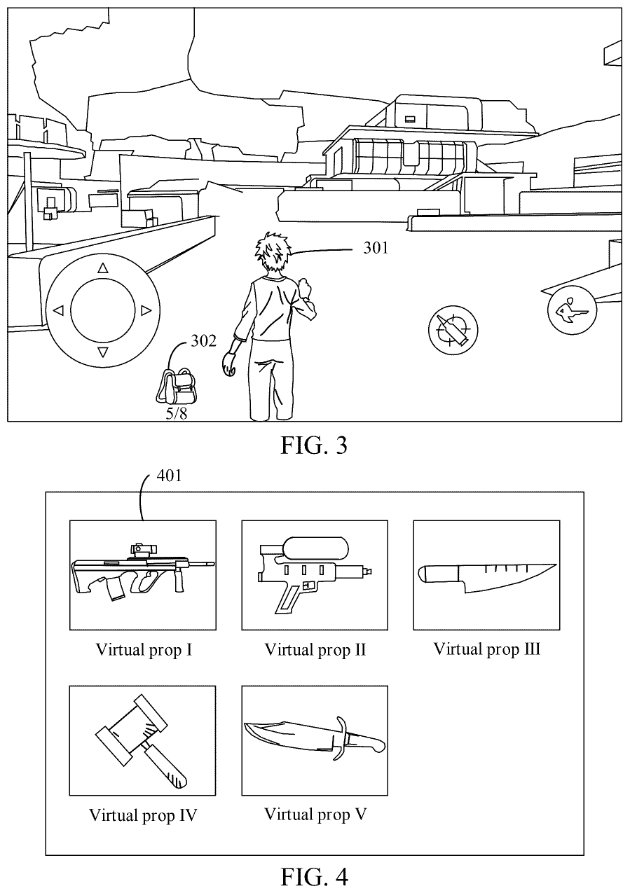

FIG. 3 is a schematic diagram showing a game picture according to an embodiment of this application. The game picture shown in FIG. 3 has displayed therein a virtual object 301 located in a virtual environment. The virtual object is in a stationary state.

In some embodiments, the game picture further has a backpack control displayed therein. For example, 302 in FIG. 3 represents the backpack control. The backpack control is configured to display a backpack page. The backpack page is a display page of a virtual backpack of the virtual object. The virtual backpack is configured to store a virtual prop owned by the virtual object. The backpack page has displayed therein prop information of a virtual prop obtained by a user. The virtual prop obtained by the user is equivalent to a virtual prop owned by the virtual object 301. The game picture further has displayed therein a capacity of the virtual backpack and a quantity of virtual props obtained by the user. The capacity of the virtual backpack refers to the quantity of virtual props that can be stored in the virtual backpack. As shown in FIG. 3, “8” is the capacity of the virtual backpack, and “5” is the quantity of virtual props obtained by the user.

In some embodiments, the backpack page is displayed in response to a trigger operation for the backpack control. Prop information of a virtual prop obtained by a user is displayed in the backpack page. The prop information of the virtual prop includes, but is not limited to, a name of the virtual prop and a picture of the virtual prop. In some embodiments, the virtual prop is a virtual firearm, or a virtual stick, or another virtual cutter, or another virtual prop. This is not limited in this embodiment of this application.

FIG. 4 is a schematic diagram showing a backpack page according to an embodiment of this application. The backpack page shown in FIG. 4 has displayed therein prop information of five virtual props obtained by a user. The prop information of the first virtual prop includes: a name (a virtual prop I) of the first virtual prop and a picture 401 of the first virtual prop. The prop information of another virtual prop is shown in FIG. 4. Details are not described herein again.

A display manner of the backpack page is not limited in this embodiment of this application. Exemplarily, the backpack page is displayed on the game picture through superimposition, or the backpack page is displayed separately. Due to a limited capacity of a backpack, a quantity of virtual props stored in a virtual backpack cannot be greater than the capacity of the virtual backpack.

In a possible implementation, in response to a selection operation for prop information of any virtual prop, the virtual object is controlled to hold the selected virtual prop. The virtual object displayed in the game picture holds the selected virtual prop. In some embodiments, that the virtual object holds the virtual prop means that the virtual object holds a virtual prop in a hand.

In this embodiment of this application, when the backpack page is displayed, in response to a selection operation performed on any one piece of prop information in the backpack page, which is equivalent to triggering an operation of selecting a virtual prop by the virtual object, the virtual object is controlled to hold the virtual prop indicated by the selected prop information.

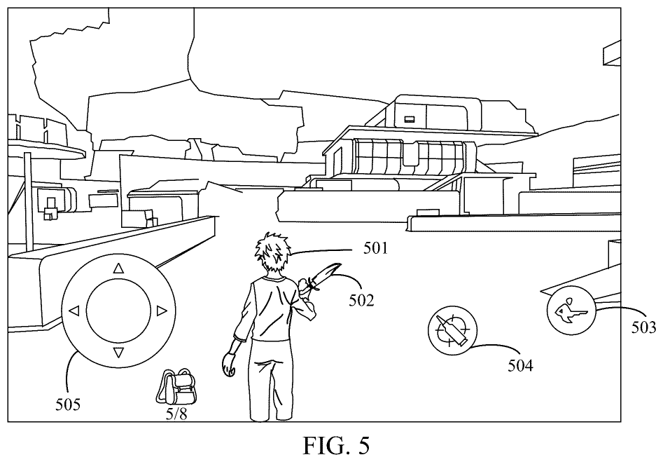

FIG. 5 is a schematic diagram showing another game picture according to an embodiment of this application. In the game picture shown in FIG. 5, a virtual object 501 holds a virtual prop 502, and the virtual object 501 is in a stationary state.

Operation 202: Obtain a whole-body animation of a virtual object in response to a trigger operation of a shooting function, the whole-body animation being an animation in which the virtual object performs a shooting operation corresponding to the shooting function through a virtual prop when being in a target state.

In this embodiment of this application, the shooting function is configured for controlling the virtual object to perform the shooting operation through the held virtual prop. In other words, the virtual object is controlled to perform shooting through the held virtual prop. The trigger operation for the shooting function is equivalent to an operation of controlling the virtual object to perform shooting through the performed virtual prop, and then a whole-body animation is obtained, so that a picture of performing the shooting operation through the virtual prop by the virtual object in the target state can be presented subsequently by displaying the whole-body animation.

In some embodiments, a process of obtaining the whole-body animation includes: generating a first animation obtaining request in response to the trigger operation of the shooting function, the first animation obtaining request including an object identifier of the virtual object, a prop identifier of the virtual prop, the target state, and target information, the target information indicating the shooting function; transmitting the first animation obtaining request to a server; and receiving the whole-body animation returned by the server based on the first animation obtaining request.

The object identifier is a unique identifier configured for representing the virtual object, and can be represented in any form. For example, the object identifier is a name or a number of the virtual object. The prop identifier is a unique identifier configured for representing the virtual prop, and can be represented in any form. For example, the prop identifier is a name, an image, or a number of the virtual prop. The target information can be represented in any form. For example, the target information is represented in a text form. For another example, considering that a plurality of shooting functions are included, the target information represents each shooting function through an identifier of each of the plurality of shooting functions.

In this embodiment of this application, the server is configured to provide the whole-body animation of the virtual object. In response to the trigger operation of the shooting function, the terminal device transmits, to the server, an animation obtaining request carrying the object identifier, the prop identifier, the target state, and the target information, so that the server can provide a matching whole-body animation based on the object identifier, the prop identifier, the target state, and the target information, to ensure that the whole-body animation can present a picture of performing the shooting operation corresponding to the shooting function through the virtual prop by the virtual object in the target state, thereby ensuring accuracy of the whole-body animation. In addition, in this manner, the terminal device does not need to generate or store the whole-body animation. This can reduce pressure on the terminal device, thereby ensuring performance of the terminal device, and reducing requirements for the terminal device.

In some embodiments, a process in which the server obtains the whole-body animation includes the following. The server has stored therein a correspondence between an object identifier, a prop identifier, a state, and information for indicating a shooting function and the whole-body animation, and the server queries the correspondence in response to the first animation obtaining request, to obtain the whole-body animation stored corresponding to the object identifier, the prop identifier, the target state, and the target information in the first animation obtaining request.

In this embodiment of this application, the server has the whole-body animation stored therein, and correspondingly stores the whole-body animation based on the object identifier, the prop identifier, the state of the virtual object, and the information for indicating the shooting function. Therefore, the server may query the correspondence in response to the animation obtaining request, and can quickly obtain the whole-body animation requested by the terminal device, thereby ensuring convenience and efficiency of obtaining the whole-body animation.

In some embodiments, the shooting function includes a hip-fire function or a shoulder-fire function.

The hip-fire function and the shoulder-fire function are two different shooting functions, and the hip-fire function and the shoulder-fire function correspond to different shooting operations. The hip-fire function refers to a function of performing shooting through a default crosshair of the virtual prop without using the virtual sight. The shoulder-fire function refers to a function of performing shooting through a virtual sight. A shooting operation corresponding to the hip-fire function is referred to as a hip-fire operation, and a shooting operation corresponding to the shoulder-fire function is referred to as a shoulder-fire operation.

The shooting function includes a hip-fire function, the shooting operation corresponding to the shooting function includes a hip-fire operation, and the target information included in the first animation obtaining request indicates the hip-fire function. Alternatively, the shooting function includes a shoulder-fire function, the shooting operation corresponding to the shooting function includes a shoulder-fire operation, and the target information included in the first animation obtaining request indicates the shoulder-fire function.

In some embodiments, the game picture has a hip-fire control displayed therein. For example, 503 in FIG. 5 represents a hip-fire control. When the shooting function is the hip-fire function, a process of triggering the hip-fire function includes: triggering the hip-fire function in response to a first operation for the hip-fire control. In other words, the whole-body animation of the virtual object is obtained in response to the first operation for the hip-fire control.

The first operation for the hip-fire control refers to a clicking/tapping operation or a short-press operation for the hip-fire control. The short-press operation refers to a pressing operation with a pressing duration less than a threshold. The threshold is any duration. For example, the threshold is 0.2 seconds. The hip-fire control is any type of control. For example, the hip-fire control is a button.

In a possible implementation, the shooting function is a hip-fire function. When the hip-fire function is triggered each time, the obtained whole-body animation may be the same or may be different. This is not limited in this embodiment of this application.

In some embodiments, when the virtual object is in the same target state and holds the same virtual prop, the whole-body animations obtained when the hip-fire function is triggered for a plurality of times are the same. To be specific, the same whole-body animation is displayed each time the hip-fire function is triggered. The triggering of the hip-fire function a plurality of times is performed at different times, which is equivalent to controlling the virtual object to perform a plurality of hip-fire operations at different times when controlling the virtual object.

For example, when the virtual object is in the same target state and holds the same virtual prop, the virtual object corresponds to only one whole-body animation. To be specific, when the virtual object is in the same target state and holds the same virtual prop, no matter how many times the hip-fire function is triggered, only the same whole-body animation is displayed.

In some embodiments, when the virtual object is in the same target state and holds the same virtual prop, the whole-body animations obtained when the hip-fire function is triggered for a plurality of times are different. To be specific, a different whole-body animation is displayed each time the hip-fire function is triggered. Among the whole-body animations obtained by triggering the hip-fire function a plurality of times, at least two whole-body animations obtained by triggering the hip-fire function are different.

For example, when the virtual object is in the same target state and holds the same virtual prop, the hip-fire function is triggered 3 times successively. In whole-body animations obtained by triggering the hip-fire function 3 times, whole-body animations obtained for the first 2 times are the same, and the whole-body animation obtained for the last time is different from the whole-body animations obtained the first 2 times. Alternatively, all whole-body animations obtained 3 times are different.

In some embodiments, a process of generating the first animation obtaining request includes: determining, in response to the trigger operation of the hip-fire function, a quantity of times the hip-fire function is triggered; and generating a first animation obtaining request based on the quantity of times the hip-fire function is triggered, the first animation obtaining request further including the quantity of times the hip-fire function is triggered, and the whole-body animation obtained based on the first animation obtaining request being a whole-body animation in which the virtual object performs a hip-fire operation through the virtual prop when the virtual object is in the target state and the quantity of triggering times the hip-fire function is triggered.

In this embodiment of this application, when the virtual object is in the same target state and holds the same virtual prop, the whole-body animations obtained by triggering the hip-fire function for a plurality of times may be different. Therefore, before generating the animation obtaining request, the terminal device first determines a quantity of times the hip-fire function is triggered, to generate the first animation obtaining request based on the quantity of triggering times, so that the first animation obtaining request includes the object identifier of the virtual object, the prop identifier of the virtual prop, the target state, the target information, and the quantity of times the hip-fire function is triggered, and the server can subsequently provide the whole-body animation based on the quantity of hip firing times, thereby implementing a solution in which the whole-body animation changes with the quantity of triggering times, and enriching diversity of the whole-body animation. This can also ensure that whole-body animations displayed when the same virtual object triggers the hip-fire function a plurality of times are different, thereby improving interestingness of a game, and improving user experience.

In some embodiments, a process of determining the quantity of times the hip-fire function is triggered includes: querying, by the terminal device based on the prop identifier, the target state, and the target information, the quantity of times the hip-fire function is triggered from operation information; or transmitting, by the terminal device, a query request to the server, the query request including the object identifier of the virtual object, the prop identifier of the virtual prop, the target state, and the target information; performing, by the server, query from the operation information based on the query request, and returning the queried quantity of triggering times to the terminal device; and receiving, by the terminal device, the quantity of triggering times returned by the server.

In the embodiments of this application, the terminal device has the operation information stored therein. The operation information is configured for recording a situation where the shooting function is triggered. In other words, a situation where the virtual object performs a shooting operation corresponding to the shooting function through the held virtual prop in each state is recorded. The operation information includes at least one operation record. Each operation record is configured for representing a situation where the virtual object performs a shooting operation through a held virtual prop in a certain state. In other words, each operation record is equivalent to triggering the shooting function once. The terminal device queries the operation record based on the prop identifier of the virtual prop currently held by the virtual object, the target state, and the target information. When the operation record includes the prop identifier, the state of the virtual object, and the information for indicating the shooting function, a quantity of operation records including the prop identifier, the target state, and the target information is queried, the quantity of found operation records being a quantity of times the hip-fire function is triggered. Alternatively, when the operation record includes the prop identifier, the state of the virtual object, the information for indicating the shooting function, and the quantity of triggering times, the operation record including the prop identifier, the target state, and the target information is queried, the quantity of triggering times included in the found operation record being the quantity of times the hip-fire function is triggered.

In the embodiments of this application, the server has operation information corresponding to each virtual object stored therein. The operation information is similar to the operation information in the foregoing terminal device. The server obtains, based on an object identifier in the query request, operation information corresponding to the object identifier, and then queries, based on the prop identifier of the virtual prop currently held by the virtual object, the target state, and the target information, the operation records corresponding to the object identifier in the foregoing manner, to query a quantity of the operation records including the prop identifier, the target state, and the target information. The quantity of found operation records is the quantity of times the hip-fire function is triggered.

In the embodiments of this application, the terminal device or the server has the operation information stored therein, so that the terminal device can obtain the quantity of times the hip-fire function is triggered by using either of the foregoing two manners.

In some embodiments, the server receives the first animation obtaining request, and parses the first animation obtaining request, to obtain the object identifier of the virtual object, the prop identifier of the virtual prop, the target state, the target information, and the quantity of times the hip-fire function is triggered. The server has stored therein a whole-body animation in which any virtual object performs, through any virtual prop at any time, a shooting operation indicated by the target information when any virtual object is in any state. The server further has stored therein a correspondence between an object identifier of any virtual object, a prop identifier of any virtual prop, any state, target information, any quantity of times, and the whole-body animation. The whole-body animation is a whole-body animation in which any virtual object performs a shooting operation indicated by the target information through any virtual prop any quantity of times when any virtual object is in any state. In other words, a correspondence of the server includes the object identifier, the prop identifier, the state, the target information, the quantity of triggering times, and the whole-body animation. The correspondence includes a plurality of possible schemes. For any situation that occurs in a virtual scene, a corresponding whole-body animation can be found based on the correspondence. In this way, based on the object identifier of the virtual object, the prop identifier of the virtual prop, the target state, the target information, and the quantity of times the hip-fire function is triggered, the server may obtain, by querying the correspondence, a whole-body animation in which the virtual object performs a hip-fire operation through the virtual prop at the quantity of times the hip-fire function is triggered when the virtual object is in the target state. Further, the server transmits the obtained whole-body animation to the terminal device, so that the terminal device obtains the whole-body animation. The whole-body animation is a whole-body animation in which the virtual object performs the hip-fire operation through the virtual prop at the quantity of times the hip-fire function is triggered when the virtual object is in the target state.

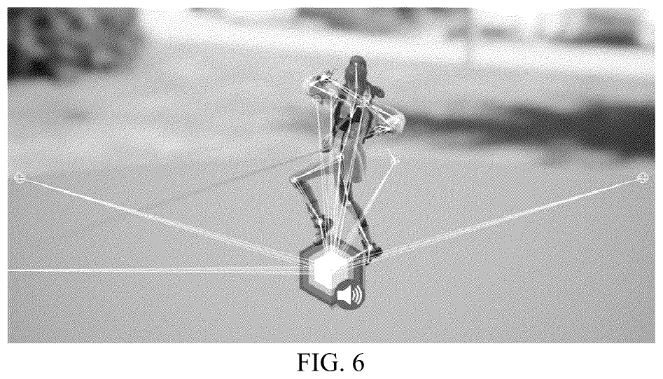

The whole-body animation is designed by an animation designer. FIG. 6 is a schematic diagram showing an animation frame in a whole-body animation according to an embodiment of this application. The whole-body animation is a whole-body animation in which a virtual object in a state performs a hip-fire operation through a virtual prop. An animation designer does not have to deal with an issue of animation blending when designing the whole-body animation, so that a proportion of each animation during playback is 100%, and the designed whole-body animation is consistent with performance that the animation designer wants to express, making the animation design less difficult. In addition, when the animation designer is unsatisfied with the designed whole-body animation, the animation designer may debug the designed whole-body animation. Since the animation is a whole-body animation, the difficulty of debugging the animation can also be reduced. After designing the whole-body animation, the animation designer integrates the whole-body animation into a montage format according to the specifications, and names the whole-body animation according to the specifications. The generated whole-body animation is stored at a corresponding location for subsequent obtaining.

The server is configured with an animation manager. A whole-body animation corresponding to any virtual object, any virtual prop, any state, target information, and any quantity of times is configured in the animation manager. In other words, the animation manager includes a whole-body animation. The whole-body animation is a whole-body animation in which any virtual object is in any state and performs a shooting operation through a virtual prop at any quantity of times. The shooting operation is a shooting operation corresponding to a shooting function indicated by the target information. When any virtual object is in any state and a shooting function indicated by the target information is triggered, a corresponding whole-body animation is obtained.

Exemplarily, when the virtual object is in the target state, a whole-body animation in which the virtual object performs a hip-fire operation through the virtual prop for the first time is a whole-body animation A. When the virtual object is in the target state, a whole-body animation in which the virtual object performs a hip-fire operation through the virtual prop for the second time is a whole-body animation B. When the virtual object is in the target state, a whole-body animation in which the virtual object performs a hip-fire operation through the virtual prop for the third time is a whole-body animation C. If the hip-fire function is triggered for a second time immediately after the hip-fire function is triggered for the first time, display of the whole-body animation A is stopped, and the whole-body animation B is displayed. In this way, no uncontrollable situations caused by superposition of a plurality of whole-body animations may occur, thereby avoiding sliding or other revealing mistakes.

In a possible implementation, the shooting function includes a shoulder-fire function, the shooting operation corresponding to the shooting function includes a shoulder-fire operation, and the target information included in the first animation obtaining request is configured for indicating the shoulder-fire function. A game picture has a shoulder-fire control displayed therein. For example, 504 in FIG. 5 represents a shoulder-fire control. A process of triggering the shoulder-fire function includes: triggering the shoulder-fire function in response to an operation of a long press for the shoulder-fire control and then a cancel of the long press. In other words, a whole-body animation of the virtual object is obtained in response to a long-press operation for the shoulder-fire control and an end of the long-press operation.

The operation of the long press for the shoulder-fire control and then the cancel of the long press is equivalent to the long-press operation for the shoulder-fire control and the end of the long-press operation. The long-press operation refers to a pressing operation with a pressing duration exceeds a threshold. The threshold is any duration. For example, the threshold is 0.2 seconds. The long-press operation for the shoulder-fire control means pressing the shoulder-fire control and the pressing duration exceeding the threshold. The end of the long-press operation means ending the shoulder-fire operation. In other words, the long-press operation for the shoulder-fire control and the end of the long-press operation mean that the shoulder-fire control is released after a duration for which the shoulder-fire control is pressed exceeds a threshold. For example, the threshold is 0.2 seconds, and the long-press operation for the shoulder-fire control and the end of the long-press operation mean that the shoulder-fire control is pressed and then released after a duration for which the shoulder-fire control is pressed exceeds 0.2 seconds. In this case, the shoulder-fire control no longer remains pressed.

In the embodiments of this application, the shoulder-fire control is configured to trigger a shoulder-fire function. The shoulder-fire function is triggered only when a long-press operation is triggered for the shoulder-fire control and the long-press operation ends, and the shoulder-fire function is not triggered when the shoulder-fire control is long-pressed. In this way, a situation of false triggering of the shoulder-fire function can be avoided, thereby ensuring accuracy of triggering the shoulder-fire function, and further improving user experience.

In the embodiments of this application, an example in which the shoulder-fire function is triggered only when a long-press operation is performed for the shoulder-fire control and the long-press operation ends is used for description. In another embodiment, a whole-body animation of a virtual object is obtained in response to the long-press operation for the shoulder-fire control. In other words, the long-press operation for the shoulder-fire control being detected is equivalent to the shoulder-fire function being triggered.

In some embodiments, a process of triggering the shoulder-fire function in response to the operation of a long press for the shoulder-fire control and then a cancel of the long press includes: obtaining a charging animation in response to the long-press operation for the shoulder-fire control, the charging animation being an animation in which charging is performed before the virtual object in a target state performs a shoulder-fire operation through a virtual prop; displaying a charging animation; and triggering a shoulder-fire function in response to the end of the long-press operation for the shoulder-fire control, namely, obtaining a whole-body animation in response to the end of the long-press operation for the shoulder-fire control. The charging animation includes an upper body charging animation and a lower body charging animation.

The long-press operation for the shoulder-fire control refers to that duration of a trigger operation for the shoulder-fire control is greater than a target duration. In other words, the duration for which the shoulder-fire control is pressed is greater than the target duration. The target duration is set based on experience or adjusted based on an implementation environment, which is not limited in this embodiment of this application. Exemplarily, the target duration is 3 seconds.

The charging animation is configured for representing a picture in which the virtual object performs charging when performing the shoulder-fire operation, so that the virtual object can perform the shoulder-fire operation subsequently upon completion of the charging.

For example, the virtual object needs to perform charging before performing the shoulder-fire operation through the virtual prop. The virtual object can perform the shoulder-fire operation through the virtual prop only after a charging value reaches a preset numerical value, and a charging animation is configured for representing a picture of performing charging before the virtual object performs the shoulder-fire operation.

For example, in a process in which the virtual object performs the shoulder-fire operation through the virtual prop, the virtual object starts a virtual sight, and then aims at a target through the virtual sight, and then the virtual object shoots the aimed target through the virtual prop. The charging animation is configured for representing a picture in which the virtual object starts the virtual sight before performing the shoulder-fire operation.

In the embodiments of this application, considering that the process of performing the shoulder-fire operation by the virtual object is relatively complex, the process of triggering the shoulder-fire function is divided into two parts. In a process of maintaining the long press on the shoulder-fire control, a charging animation is obtained and displayed, to present a related preparation action performed by the virtual object before performing the shoulder-fire operation. Then when the long-press operation for the shoulder-fire control ends, a whole-body animation of the virtual object is obtained and displayed, to present a picture of performing the shoulder-fire operation through the virtual prop by the virtual object in the target state. In this way, different animations can be displayed through one operation, and a user does not need to perform complex operations, thereby improving human-computer interaction efficiency, also ensuring integrity of the picture in which the virtual object performs the shoulder-fire operation, improving a display effect of an animation, and further improving user experience.

In some embodiments, a charging progress bar is displayed in response to the long-press operation for the shoulder-fire control. The charging progress bar indicates a charged value of the virtual object and a chargeable value of the virtual object. The charged value of the virtual object is in direct proportion to a duration of the long-press operation for the shoulder-fire control. In other words, a longer duration of the long-press operation for the shoulder-fire control indicates a larger charged value of the virtual object. Conversely, a shorter duration of the long-press operation for the shoulder-fire control indicates a smaller charged value of the virtual object. The charged value of the virtual object and the chargeable value of the virtual object are displayed in different manners in the charging progress bar.

The chargeable value of the virtual object is equivalent to a maximum value of the charging value of the virtual object. The charged value of the virtual object gradually increases with the duration for which the shoulder-fire control is pressed. For example, a chargeable value of the virtual object is 100. Starting from pressing the shoulder-fire control, the charged value in the charging progress bar gradually increases from 0 to 100.

In the embodiments of this application, in the process of maintaining the long press on the shoulder-fire control, not only the charging animation is displayed, but also the charging progress bar is displayed, to indicate a charging progress, so that the user can determine, based on the charging progress, whether the shoulder-fire control is no longer pressed. In this way, it is convenient for the user to select an occasion to stop pressing the shoulder-fire control, which is equivalent to making it convenient for the user to select an occasion to trigger the shoulder-fire function, thereby ensuring an effect of subsequently performing the shoulder-fire operation by the virtual object, enriching displayed content, and improving user experience.

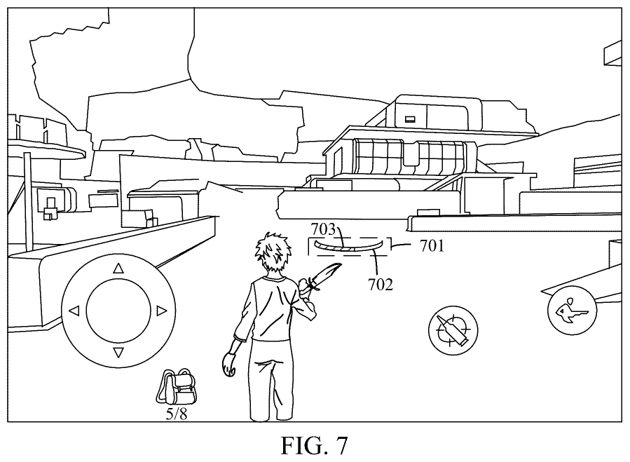

FIG. 7 is a schematic diagram showing another game picture according to an embodiment of this application. The game picture shown in FIG. 7 has a charging progress bar 701 displayed therein. 702 indicates a chargeable value of a virtual object, and 703 indicates a charged value of the virtual object.

In some embodiments, a process of obtaining, in response to a long-press operation for a shoulder-fire control, a charging animation before the virtual object performs a shoulder-fire operation through a virtual prop when being in a target state includes: generating a second animation obtaining request in response to the long-press operation for the shoulder-fire control, the second animation obtaining request including an object identifier of the virtual object, a prop identifier of the virtual prop, and the target state, and the second animation obtaining request being configured for obtaining an animation in which the virtual object performs charging before performing the shoulder-fire operation through the virtual prop when being in the target state; transmitting the second animation obtaining request to a server; and receiving the charging animation returned by the server based on the second animation obtaining request.

The process in which the server receives the second animation obtaining request and obtains the charging animation based on the second animation obtaining request is similar to the foregoing process in which the server obtains a whole-body animation based on the first animation obtaining request. Details are not described herein again in this embodiment of this application.

In a possible implementation, a shooting function is a shoulder-fire function. Target information included in the first animation obtaining request indicates the shoulder-fire function. The game picture has a direction control displayed therein. For example, 505 in FIG. 5 represents a direction control. A process of generating the first animation obtaining request in response to a trigger operation for the shooting function includes: determining a movement direction of the direction control in response to a trigger operation of the shoulder-fire function and a trigger operation for the direction control; and generating the first animation obtaining request based on the movement direction. The first animation obtaining request further includes the movement direction. The whole-body animation obtained based on the first animation obtaining request is a whole-body animation in which the virtual object performs the shoulder-fire operation in the movement direction through the virtual prop when being in the target state. In other words, the whole-body animation is a whole-body animation in which the virtual object moves along the movement direction in the target state and performs the shoulder-fire operation through the virtual prop.

The movement direction is any one movement direction of moving to the left, moving to the right, moving forward, moving backward, moving to the left front, moving to the right front, moving to the left rear, or moving to the right rear. The direction control is configured to control the movement of the virtual object in a virtual scene, and the trigger operation for the direction control is equivalent to an operation of controlling the movement of virtual object in the virtual scene. The movement direction for the direction control refers to a movement direction indicated when the direction control is triggered. As shown in 505 in FIG. 5, the direction control is a virtual joystick. The virtual joystick includes two circles. The large circle is equivalent to a virtual wheel. The small circle can be dragged to move in the virtual wheel. In a default state of the virtual joystick, centers of the two circles overlap. The user drags the small circle to move in the large circle, which is equivalent to the trigger operation for the direction control. A direction in which the center of the small circle is equivalent to the center of the large circle is configured for representing the movement direction.

In the embodiments of this application, considering that the virtual object may further move during shooting, when the shoulder-fire function is triggered, the direction control is further triggered, which indicates that not only the virtual object is controlled to perform the shoulder-fire operation, but also the virtual object is controlled to move. Therefore, the whole-body animation is obtained based on the movement direction indicated by the direction control, so that the obtained whole-body animation not only can present a picture of the virtual object performing the shoulder-fire operation through the virtual prop when being in the target state, but also can present a picture of the virtual object moving along the movement direction. In other words, the whole-body animation can reflect a picture of the virtual object performing the shoulder-fire operation while moving, to ensure that the displayed whole-body animation matches the triggered operation, thereby avoiding a situation in which the user triggers a movement operation but the virtual object does not move, ensuring a picture display effect, and improving user experience.

In some embodiments, the server has stored therein a correspondence between a prop identifier, a state, information for indicating a shooting function, a movement direction, and a whole-body animation. The process in which the server obtains the whole-body animation includes: querying, by the server, the correspondence in response to the first animation obtaining request, to obtain the whole-body animation stored corresponding to the object identifier, the prop identifier, the target state, the target information, and the movement direction in the first animation obtaining request.

In this embodiment of this application, the server has the whole-body animation stored therein, and correspondingly stores the whole-body animation based on the object identifier, the prop identifier, the state of the virtual object, the information for indicating the shooting function, and the movement direction. Therefore, the server may query the correspondence in response to the animation obtaining request, and can quickly obtain the whole-body animation requested by the terminal device, thereby ensuring convenience and efficiency of obtaining the whole-body animation.

When the triggered shooting functions are different, the processes of obtaining the whole-body animation in which the virtual object performs the shooting operation through the virtual prop when being in the target state are different. For different shooting functions, the whole-body animation in which the virtual object performs the shooting operation through the virtual prop when being in the target state is obtained in the foregoing shown manner.

The object identifier of the virtual object is a name of the virtual object, or a number of the virtual object, or another identifier that can uniquely represent the virtual object. The prop identifier of the virtual prop is a name of the virtual prop, a number of the virtual prop, or another identifier that can uniquely represent the virtual prop. This is not limited in the embodiments of this application.

Operation 203: Display the whole-body animation.

After the whole-body animation in which the virtual object performs the shooting operation corresponding to the shooting function through the virtual prop when being in the target state is obtained in the foregoing operation 202, the whole-body animation is displayed, to achieve the purpose of the virtual object performing the shooting operation through the virtual prop. Exemplarily, the whole-body animation is displayed in a game picture. In some embodiments, when the whole-body animation is displayed in the game picture, the virtual object is undisplayed in the game picture. In the embodiments of this application, the whole-body animation is configured for representing a picture of performing a shooting operation corresponding to a shooting function through the virtual prop when the virtual object is in the target state, and display of the whole-body animation is also equivalent to the virtual object performing the shooting operation in the virtual scene.

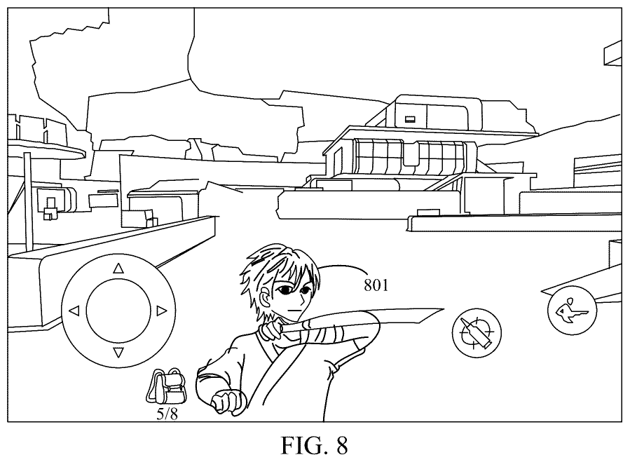

For example, the shooting function is a hip-fire function. If an obtained whole-body animation in which the virtual object performs a hip-fire operation through the virtual prop when being in the target state is a whole-body animation A, then the whole-body animation A is displayed. FIG. 8 is a schematic diagram showing a game picture according to an embodiment of this application. The game picture shown in FIG. 8 is any picture frame of the whole-body animation A, and 801 in FIG. 8 indicates a virtual object.

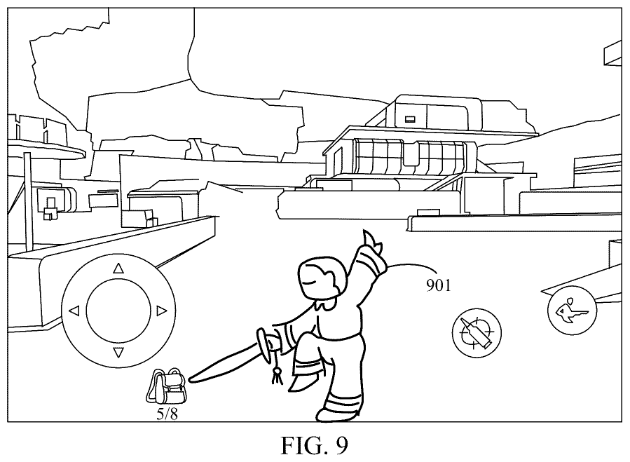

For example, a shooting function is a hip-fire function. If an obtained whole-body animation in which the virtual object performs a hip-fire operation through the virtual prop when being in the target state is a whole-body animation B, then the whole-body animation B is displayed. FIG. 9 is a schematic diagram showing a game picture according to an embodiment of this application. The game picture shown in FIG. 9 is any picture frame in a whole-body animation B, and 901 in FIG. 9 indicates a virtual object.

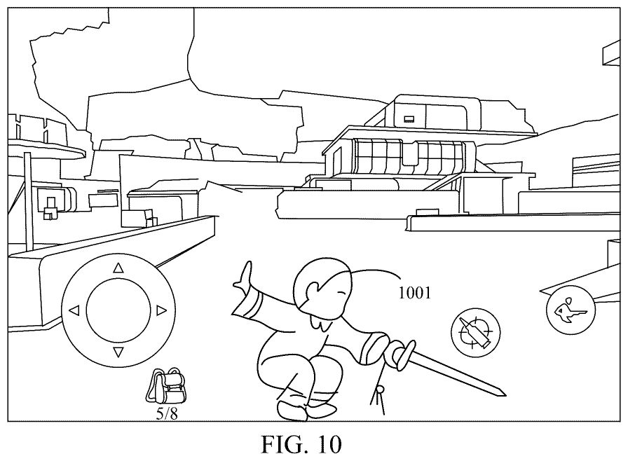

For example, the shooting function is a hip-fire function. If an obtained whole-body animation in which the virtual object performs a hip-fire operation through the virtual prop when being in the target state is a whole-body animation C, then the whole-body animation C is displayed. FIG. 10 is a schematic diagram showing a game picture according to an embodiment of this application. The game picture shown in FIG. 10 is any picture frame of the whole-body animation C, and 1001 in FIG. 10 indicates a virtual object.

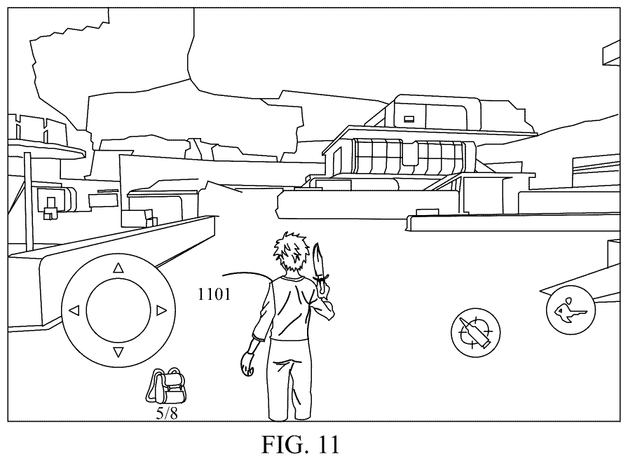

For example, a shooting function is a shoulder-fire function. If a whole-body animation in which the virtual object performs a shoulder-fire operation forward through a virtual prop when being in a target state is obtained, then the whole-body animation is displayed. FIG. 11 is a schematic diagram showing a game picture according to an embodiment of this application. The game picture shown in FIG. 11 is any picture frame of the whole-body animation, and 1101 in FIG. 11 indicates a virtual object.

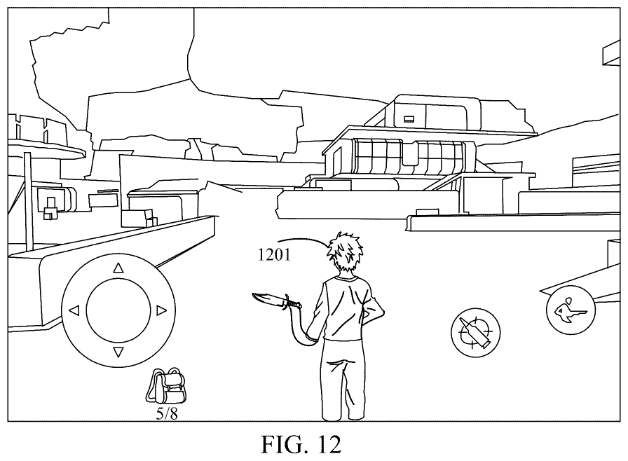

For example, a shooting function is a shoulder-fire function. If a whole-body animation in which the virtual object performs a shoulder-fire operation leftward through a virtual prop when being in a target state is obtained, then the whole-body animation is displayed. FIG. 12 is a schematic diagram showing a game picture according to an embodiment of this application. The game picture shown in FIG. 12 is any picture frame of the whole-body animation, and 1201 in FIG. 12 indicates a virtual object.

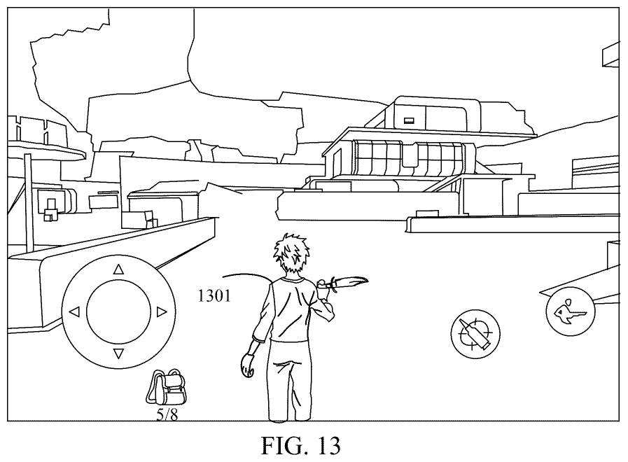

For example, a shooting function is a shoulder-fire function. If a whole-body animation in which the virtual object performs a shoulder-fire operation rightward through a virtual prop when being in a target state is obtained, then the whole-body animation is displayed. FIG. 13 is a schematic diagram showing a game picture according to an embodiment of this application. The game picture shown in FIG. 13 is any picture frame of the whole-body animation, and 1301 in FIG. 13 indicates a virtual object.

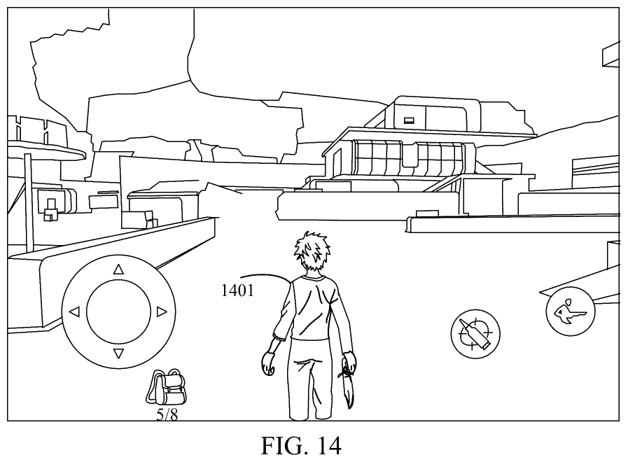

For example, a shooting function is a shoulder-fire function. If a whole-body animation in which the virtual object performs a shoulder-fire operation rearward through a virtual prop when being in a target state is obtained, then the whole-body animation is displayed. FIG. 14 is a schematic diagram showing a game picture according to an embodiment of this application. The game picture shown in FIG. 14 is any picture frame of the whole-body animation, and 1401 in FIG. 14 indicates a virtual object.

In a possible implementation, a shooting function is a shoulder-fire function. A movement distance for a direction control is determined in response to a trigger operation for the direction control. A second location is determined based on a movement direction, the movement distance, and a first location. A distance between the second location and the first location is the movement distance. The second location is in the movement direction of the first location. The first location is a location of the virtual object in a virtual environment when the direction control is triggered. A whole-body animation indicates that the virtual object moves toward the second location when performing a shooting operation, the whole-body animation is displayed, and the virtual object is displayed at the second location in response to an end of the whole-body animation. That the movement distance for the direction control is determined in response to the trigger operation for the direction control is equivalent to that the movement distance for the direction control is determined in response to the trigger operation of the shooting function and the trigger operation for the direction control.

In this embodiment of this application, the first location is equivalent to a location where the virtual object is located before the virtual object moves based on the movement direction indicated by the direction control. The second location is equivalent to a location reached by the virtual object after moving based on the movement direction indicated by the direction control. In response to the trigger operation for the direction control, the virtual object is controlled to move in a virtual scene. If the shooting function is not triggered in this case, the virtual object moving from the first location to the second location in the virtual scene is displayed. However, since the shooting function is further triggered when the direction control is triggered, the obtained whole-body animation not only can present a picture in which the virtual object performs a shoulder-fire operation through a virtual prop when being in a target state, but also can present a picture in which the virtual object moves from the first location to the second location. After an end of the whole-body animation, the virtual object being located at the second location is displayed. In this way, the whole-body animation can reflect the picture in which the virtual object moves in the virtual scene, so that a location of the virtual object in the displayed picture is the same as a real location of the virtual object, thereby ensuring that the displayed whole-body animation matches the triggered operation, ensuring continuity of the game picture, improving a display effect, and further improving user experience.

In some embodiments, that the movement distance for the direction control is determined includes: a product of a movement speed of the virtual object and a duration of the whole-body animation is determined as the movement distance in response to the trigger operation of the shooting function and the trigger operation for the direction control.

The movement speed of the virtual object is any preset speed. For example, the movement speed of the virtual object is 1 meter per second. A duration of the whole-body animation is any duration. For example, the duration of the whole-body animation is 2 seconds.

In the embodiments of this application, in the whole-body animation, the virtual object also moves along the direction indicated by the direction control and based on the movement speed, and then the product of the movement speed of the virtual object and the duration of the whole-body animation is determined as the movement distance, to ensure that the location of the virtual object in the whole-body animation is the same as a location of the virtual object in the virtual scene when the whole-body animation ends, avoid a situation of different locations, ensure coherence of picture display, and ensure a display effect of a picture.

In some embodiments, a process of displaying the whole-body animation includes: displaying the whole-body animation at the second location.

In this embodiment of this application, the whole-body animation is displayed at the second location, to reflect a scheme in which the virtual object performs shooting toward the movement direction, so that the display effect can be ensured.

In some embodiments, to avoid common problems of retargeting and an excessively long playback time in the whole-body animation, when the whole-body animation is displayed, relatively free disruptions and other connection animations such as firing/running/sprinting need to be supported. Therefore, backend resources for the whole-body animation require optimization of animation transition performances or blending of connection animations to ensure flexible and high-quality disruption processing. Since the whole-body animation essentially has only one animation, the whole-body animation is more convenient than the animation blending in resource processing. However, at the level of interruption and transition in a state machine, since the transition to another animation is performed through the whole-body animation rather than an upper-body animation, which is a process of the transition from the whole-body animation to an animation blending, and requires sufficient transition time to be left, to implement better blending performance or allow for direct playback of connection animations. The whole-body animation inherently involves multi-directional displacement, and a displacement distance is often written in an animation blueprint, which needs to be matched on a client. When the whole-body animation ends and transitions to another state such as running/sprinting, displacement of the another state is determined by the client rather than the animation. Displacement driving manners of the two states are different, which easily cause the virtual object to stop in the same place at a speed of zero in the transition stage, and the displacement driving manner of the animation blending starts to be used in the transition stage. During connection of a whole-body animation to a whole-body animation, a displacement speed also needs to be separately assigned. Otherwise, a displacement between the whole-body animation and the whole-body animation is zero and a speed is zero, and the virtual object still stops in the same place.

In a possible implementation, the whole-body animation in which the virtual object performs the hip-fire operation through the virtual prop when being in the target state is obtained in response to the duration of the trigger operation for the shoulder-fire control being less than the target duration (in other words, in response to the trigger operation for the shoulder-fire control being not a long-press operation), and the whole-body animation in which the virtual object performs the hip-fire operation through the virtual prop when being in the target state is displayed. The process in which the whole-body animation in which the virtual object performs the hip-fire operation through the virtual prop when being in the target state is obtained in response to the duration of the trigger operation for the shoulder-fire control being less than the target duration is similar to the foregoing process in which the whole-body animation in which the virtual object performs the hip-fire operation through the virtual prop when being in the target state is obtained in response to the trigger operation of the hip-fire function. Details are not described herein again in the embodiments of this application.

In the embodiments of this application, a long-press operation for the shoulder-fire control is equivalent to an operation of triggering the virtual object to perform the shoulder-fire operation, and a short-press operation for the shoulder-fire control is equivalent to an operation of triggering the virtual object to perform the hip-fire operation, thereby implementing a solution of realizing two different shooting manners through the same control. In this way, excessive controls do not need to be displayed in the game picture, thereby ensuring the display effect of the picture. In addition, a user does not need to separately click/tap different controls to implement different shooting manners, facilitating the operation performed by the user, so that the user can switch the shooting manner of the virtual object at any time, thereby improving human-computer interaction efficiency.

The foregoing embodiment is described through the shoulder-fire control as an example. However, in another embodiment, only one shooting control of a shooting function is displayed in the game picture, and the shooting control is a shoulder-fire control or a hip-fire control. In response to a long-press operation for the shooting control, which is equivalent to triggering a shoulder-fire function, a whole-body animation is displayed based on the foregoing process of triggering the shoulder-fire function. In response to a short-press operation for the shooting control, which is equivalent to triggering a hip-fire function, a whole-body animation is displayed based on the foregoing process of triggering the hip-fire function.

In a possible implementation, the game picture further has a shooting control of the shooting function displayed therein, the shooting function includes a hip-fire function or a shoulder-fire function, the whole-body animation includes a first whole-body animation or a second whole-body animation, a shooting operation corresponding to the hip-fire function includes a hip-fire operation, a shooting operation corresponding to the shoulder-fire function includes a shoulder-fire operation, the first whole-body animation is an animation in which the virtual object performs the hip-fire operation through the virtual prop when being in the target state, the second whole-body animation is an animation in which the virtual object performs the shoulder-fire operation through the virtual prop when being in the target state, and the process of displaying the whole-body animation includes: obtaining a first whole-body animation in response to a short-press operation on the shooting control; or obtaining a second whole-body animation in response to a long-press operation on the shooting control; and displaying the obtained whole-body animation.

The foregoing process of obtaining the first whole-body animation is similar to the foregoing process of obtaining the whole-body animation in which the virtual object performs the hip-fire operation through the virtual prop when being in the target state, and the foregoing process of obtaining the second whole-body animation is similar to the foregoing process of obtaining the whole-body animation in which the virtual object performs the shoulder-fire operation through the virtual prop when being in the target state. Details are not described herein again.

In the solutions provided in the embodiments of this application, when the shooting function is triggered, a whole-body animation of the virtual object is obtained when the virtual object is in the target state and performs the shooting operation corresponding to the shooting function through the virtual prop, and then the obtained whole-body animation is displayed. According to the method, the whole-body animation of the virtual object is obtained when the virtual object performs the shooting operation through the virtual prop, so that a subsequent animation display process is more coherent, and a shooting effect of the shooting operation performed by the virtual object through the virtual prop is better, thereby increasing the usage rate of the shooting function of the virtual object, and increasing an interaction rate of a game.

Based on the foregoing embodiment, the whole-body animation can further be obtained in another manner.

In a possible implementation, the process of obtaining the whole-body animation includes: obtaining, in response to the trigger operation of the shooting function, the whole-body animation based on a quantity of times the shooting function is triggered, the whole-body animation being the animation in which the virtual object performs the shooting operation through the virtual prop when the virtual object is in the target state and the shooting function is triggered for the quantity of times.

The shooting function is a hip-fire function or a shoulder-fire function.

In the embodiments of this application, when the virtual object is in the same target state and holds the same virtual prop, the whole-body animations obtained by triggering the shooting function for a plurality of times may be different. Then a terminal device obtains the whole-body animation based on the quantity of times the shooting function is triggered, thereby implementing a solution in which the whole-body animation changes with the quantity of times the shooting function is triggered, and enriching diversity of the whole-body animation. This can also ensure that whole-body animations displayed when the same virtual object triggers the hip-fire function a plurality of times are different, thereby improving interestingness of a game, and improving user experience.

In some embodiments, the shooting function corresponds to n whole-body animations, n being an integer greater than 1. The process of obtaining the whole-body animation includes: determining, as a to-be-displayed whole-body animation, a whole-body animation among the n whole-body animations with a serial number being the quantity of triggering times when the quantity of times the shooting function is triggered is less than n; determining a last whole-body animation among the n whole-body animations as the to-be-displayed whole-body animation when the quantity of times the shooting function is triggered is greater than n and the quantity of triggering times is an integer multiple of n; determining, when the quantity of times the shooting function is triggered is greater than n and the quantity of triggering times is not an integer multiple of n, and a remainder is obtained after the quantity of times the shooting function is triggered is divided by n, the whole-body animation with the serial number of the remainder among the n whole-body animations as the to-be-displayed whole-body animation.

Among the n whole-body animations, at least one of an action performed by the virtual object, a state of the virtual object, or a virtual prop used by the virtual object is different in different whole-body animations. In some embodiments, the shooting function includes a hip-fire function or a shoulder-fire function. A whole-body animation corresponding to the hip-fire function is different from a whole-body animation corresponding to the shoulder-fire function.

In the embodiments of this application, the shooting function corresponds to n whole-body animations. When the shooting function is triggered for a plurality of times, loop playback is performed based on an arrangement sequence of the n whole-body animations. In this way, not only a picture of performing shooting by the virtual object can be presented in a form of the whole-body animation, but also diversity of the whole-body animation can be ensured, thereby ensuring the display effect of the whole-body animation.

For example, an example in which the shooting function is the hip-fire function is used. 3 whole-body animations corresponding to the hip-fire function are respectively a whole-body animation 1, a whole-body animation 2, and a whole-body animation 3. The whole-body animation 1 is displayed when the hip-fire function is triggered for the first time. The whole-body animation 2 is displayed when the hip-fire function is triggered for the second time. The whole-body animation 3 is displayed when the hip-fire function is triggered for the third time. The whole-body animation 1 is displayed when the hip-fire function is triggered for the fourth time. The whole-body animation 3 is displayed when the hip-fire function is triggered for the fifth time. Subsequently, the whole-body animation is displayed in the same manner.

In another possible implementation, the game picture has a direction control displayed therein. A process of obtaining the whole-body animation includes: obtaining the whole-body animation based on a movement direction for the direction control in response to the trigger operation of the shooting function and a trigger operation for the direction control, the whole-body animation being an animation in which the virtual object moves along the movement direction in the target state and performs the shooting operation through the virtual prop.

In the embodiments of this application, considering that the virtual object may further move during shooting, when the shoulder-fire function is triggered, the direction control is further triggered, which indicates that not only the virtual object is controlled to perform the shoulder-fire operation, but also the virtual object is controlled to move. Therefore, the whole-body animation is obtained based on the movement direction indicated by the direction control, so that the obtained whole-body animation not only can present a picture of the virtual object performing the shoulder-fire operation through the virtual prop when being in the target state, but also can present a picture of the virtual object moving along the movement direction. In other words, the whole-body animation can reflect a picture of the virtual object performing the shoulder-fire operation while moving, to ensure that the displayed whole-body animation matches the triggered operation, thereby avoiding a situation in which the user triggers a movement operation but the virtual object does not move, ensuring a picture display effect, and improving user experience.

In some embodiments, the terminal device has displayed therein a correspondence between a prop identifier, a state, information or indicating a shooting function, a movement direction, and a whole-body animation. Then the process of obtaining the whole-body animation includes: querying, by the terminal device in response to the trigger operation of the shooting function and the trigger operation for the direction control, the correspondence based on a prop identifier of a virtual prop held by the virtual object, a target state, target information, and a movement direction, to obtain a whole-body animation stored corresponding to the prop identifier of the virtual prop held by the virtual object, the target state, the target information, and the movement direction.

In this embodiment of this application, the terminal device has the whole-body animation stored therein, and correspondingly stores the whole-body animation based on the object identifier, the prop identifier, the state of the virtual object, the information for indicating the shooting function, and the movement direction. Therefore, an accurate whole-body animation can be quickly obtained by querying the correspondence, thereby ensuring convenience and efficiency of obtaining the whole-body animation.

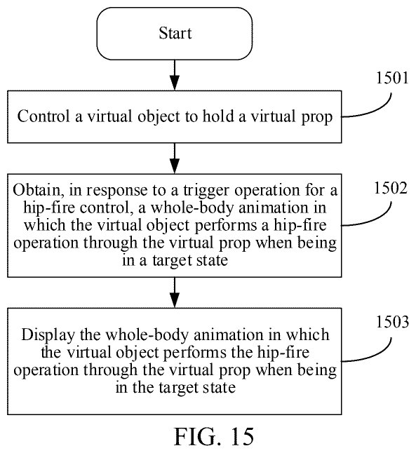

FIG. 15 is a flowchart of an animation display method according to an embodiment of this application. As shown in FIG. 15, the method includes the following operation 1501 to operation 1503.

Operation 1501: Control a virtual object to hold a virtual prop.

In a possible implementation, a process of controlling the virtual object to hold the virtual prop has been described in the foregoing operation 201, and details are not described herein again.

Operation 1502: Obtain, in response to a trigger operation for a hip-fire control, a whole-body animation in which the virtual object performs a hip-fire operation through the virtual prop when being in a target state.

In a possible implementation, the process of obtaining, in response to the trigger operation for the hip-fire control, the whole-body animation in which the virtual object performs the hip-fire operation through the virtual prop when being in the target state has been described in the foregoing operation 202, and details are not described herein again.

Operation 1503: Display the whole-body animation in which the virtual object performs the hip-fire operation through the virtual prop when being in the target state.

In a possible implementation, the process of displaying the whole-body animation in which the virtual object performs the hip-fire operation through the virtual prop when being in the target state has been described in the foregoing operation 203, and details are not described herein again.

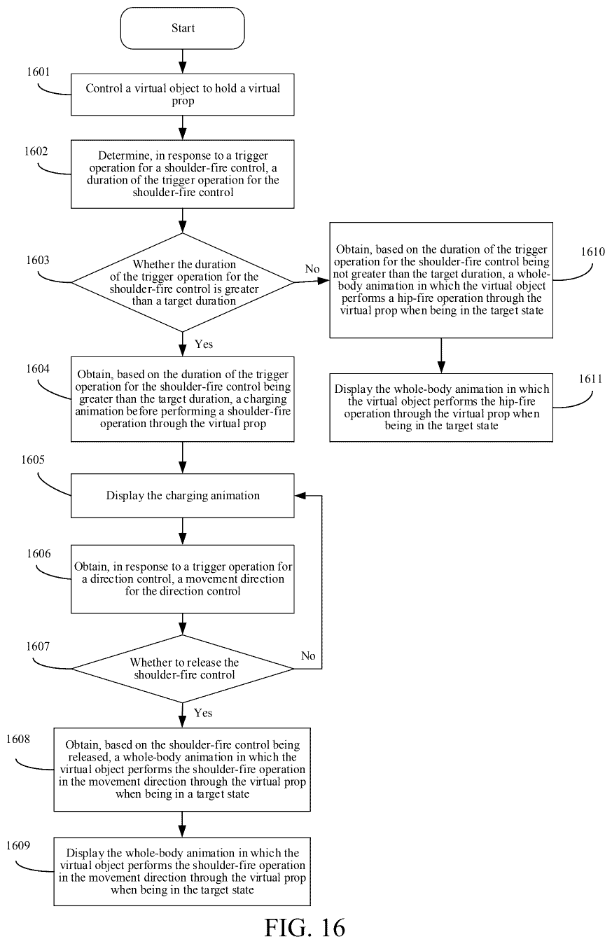

FIG. 16 is a flowchart of an animation display method according to an embodiment of this application. As shown in FIG. 16, the method includes the following operation 1601 to operation 1611.

Operation 1601: Control a virtual object to hold a virtual prop.

In a possible implementation, the process of controlling the virtual object to hold the virtual prop has been described in the foregoing operation 202, and details are not described herein again.

Operation 1602: Determine, in response to a trigger operation for a shoulder-fire control, a duration of the trigger operation for the shoulder-fire control.

In a possible implementation, the process of determining the duration of the trigger operation for the shoulder-fire control has been described in the foregoing operation 202, and details are not described herein again.

Operation 1603: Determine whether the duration of the trigger operation for the shoulder-fire control is greater than a target duration.

Operation 1604: Obtain, based on the duration of the trigger operation for the shoulder-fire control being greater than the target duration, a charging animation before performing a shoulder-fire operation through the virtual prop.

In a possible implementation, the process of obtaining the charging animation before performing the shoulder-fire operation through the virtual prop has been described in the foregoing operation 202, and details are not described herein again.

Operation 1605: Display the charging animation.

In a possible implementation, the process of displaying the charging animation has been described in the foregoing operation 202, and details are not described herein again.

Operation 1606: Obtain, in response to a trigger operation for a direction control, a movement direction for the direction control.

In a possible implementation, the process of obtaining, in response to the trigger operation for the direction control, the movement direction for the direction control has been described in the foregoing operation 202, and details are not described herein again.

Operation 1607: Determine whether to release the shoulder-fire control.

Operation 1608: Obtain, based on the shoulder-fire control being released, a whole-body animation in which the virtual object performs the shoulder-fire operation in the movement direction through the virtual prop when being in a target state.

In a possible implementation, the process of obtaining the whole-body animation in which the virtual object performs the shoulder-fire operation in the movement direction through the virtual prop when being in the target state has been described in the foregoing operation 202, and details are not described herein again.

Operation 1605 continues to be performed based on the shoulder-fire control being not released.

Operation 1609: Display the whole-body animation in which the virtual object performs the shoulder-fire operation in the movement direction through the virtual prop when being in the target state.

In a possible implementation, the process of displaying the whole-body animation in which the virtual object performs the shoulder-fire operation in the movement direction through the virtual prop when being in the target state has been described in the foregoing operation 203, and details are not described herein again.

Operation 1610: Obtain, based on the duration of the trigger operation for the shoulder-fire control being not greater than the target duration, a whole-body animation in which the virtual object performs a hip-fire operation through the virtual prop when being in the target state.

In a possible implementation, the process of obtaining, based on the duration of the trigger operation for the shoulder-fire control being not greater than the target duration, the whole-body animation in which the virtual object performs a hip-fire operation through the virtual prop when being in the target state has been described in the foregoing operation 202, and details are not described herein again.

Operation 1611: Display the whole-body animation in which the virtual object performs the hip-fire operation through the virtual prop when being in the target state.

In a possible implementation, the process of displaying the whole-body animation in which the virtual object performs the hip-fire operation through the virtual prop when being in the target state has been described in the foregoing operation 203, and details are not described herein again.

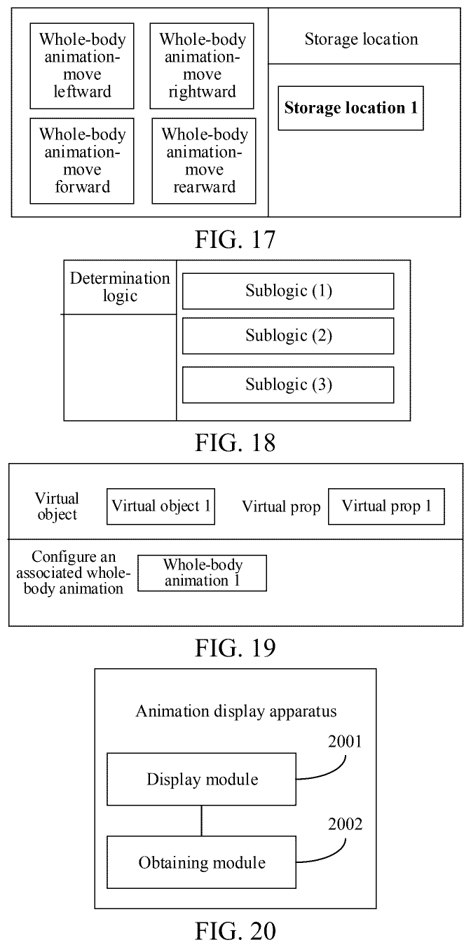

Based on the foregoing embodiment, the whole-body animation of the virtual object can be produced through a development tool. When a plurality of whole-body animations are developed for the virtual object, the produced whole-body animations can be stored through the development tool. Considering that when the same shooting function is triggered, and the virtual object has the same target state and holds the same virtual prop, a plurality of different whole-body animations may be set. When the same shooting function is triggered, and the virtual object has the same target state and holds the same virtual prop, an example in which 4 whole-body animations are set for a plurality of movement directions is used. The 4 whole-body animations are stored at the same storage location 1 in a manner shown in FIG. 17 through the development tool.

In addition, a determination logic is configured in a manner shown in FIG. 18 through the development tool, to subsequently obtain a matched whole-body animation based on the determination logic according to the foregoing embodiment. The determination logic includes 3 sublogics: (1) determining, based on a trigger operation for a shooting control of the shooting function, whether a hip-fire function or a shoulder-fire function is triggered, namely, determining whether to perform hip fire or aiming and shooting; (2) determining whether a plurality of whole-body animations need to be played; and (3) determining that a firing animation in which direction is to be played.

In addition, through the development tool, in a manner shown in FIG. 19, when a virtual object and a virtual prop held by the virtual object are selected, an associated whole-body animation is configured for the virtual object, so that the associated whole-body animation can reflect a picture in which the virtual object performs a shooting operation through the virtual prop, and subsequently according to the embodiment shown above, when the shooting function is triggered for the virtual object and the virtual object holds the virtual prop, the associated whole-body animation can be obtained.

FIG. 20 is a schematic structural diagram of an animation display apparatus according to an embodiment of this application. As shown in FIG. 20, the apparatus includes:
a display module 2001, configured to display a game picture, the game picture including a virtual object located in a virtual environment, the virtual object holding a virtual prop, the virtual object being in a target state, and the target state being any one of a stationary state, a running state, or a walking state; and
an obtaining module 2002, configured to obtain a whole-body animation of the virtual object in response to a trigger operation of a shooting function, the whole-body animation being an animation in which the virtual object performs a shooting operation through the virtual prop when being in the target state; and
the display module 2001 being further configured to display the whole-body animation.

In a possible implementation, the obtaining module 2002 is configured to obtain, in response to the trigger operation of the shooting function, the whole-body animation based on a quantity of times the shooting function is triggered, the whole-body animation being the animation in which the virtual object performs the shooting operation through the virtual prop when the virtual object is in the target state and the shooting function is triggered for the quantity of times.

In a possible implementation, the game picture has a direction control displayed therein. The obtaining module 2002 is configured to obtain the whole-body animation based on a movement direction for the direction control in response to the trigger operation of the shooting function and a trigger operation for the direction control, the whole-body animation being an animation in which the virtual object moves along the movement direction in the target state and performs the shooting operation through the virtual prop.

In a possible implementation, the apparatus further includes:
a determining module, configured to: determine, in response to the trigger operation of the shooting function and the trigger operation for the direction control, a movement distance for the direction control; and determine a second location based on the movement direction, the movement distance, and a first location, a distance between the second location and the first location being the movement distance, the second location being in the movement direction of the first location, the first location being a location of the virtual object in the virtual environment when the direction control is triggered, and the whole-body animation indicating that the virtual object moves toward the second location when performing the shooting operation; and
a display module 2001, further configured to display the virtual object at the second location in response to an end of the whole-body animation.

In a possible implementation, the determining module is configured to determine a product of a movement speed of the virtual object and a duration of the whole-body animation as the movement distance in response to the trigger operation of the shooting function and the trigger operation for the direction control.

In a possible implementation, the obtaining module 2002 is configured to: generate a first animation obtaining request in response to the trigger operation of the shooting function, the first animation obtaining request including an object identifier of the virtual object, a prop identifier of the virtual prop, the target state, and target information, the target information indicating the shooting function; transmit the first animation obtaining request to a server; and receive the whole-body animation returned by the server based on the first animation obtaining request.

In a possible implementation, the shooting function includes a hip-fire function, the shooting operation corresponding to the shooting function includes a hip-fire operation, and the target information included in the first animation obtaining request is configured for indicating the hip-fire function.

The obtaining module 2002 is configured to: determine, in response to a trigger operation of a hip-fire function, a quantity of times the hip-fire function is triggered; and generate the first animation obtaining request based on the quantity of times the hip-fire function is triggered, the first animation obtaining request further including the quantity of times the hip-fire function is triggered, and the whole-body animation being the animation in which the virtual object performs the hip-fire operation through the virtual prop when the virtual object is in the target state and the hip-fire function is triggered for the quantity of times.

In a possible implementation, the shooting function includes a shoulder-fire function, the shooting operation corresponding to the shooting function includes a shoulder-fire operation, the target information indicates the shoulder-fire function, and the game picture has a direction control displayed therein.

The obtaining module 2002 is configured to determine, in response to a trigger operation of a shoulder-fire function and the trigger operation for the direction control, a movement direction for the direction control; and generate the first animation obtaining request based on the movement direction, the first animation obtaining request further including the movement direction, and the whole-body animation being a whole-body animation in which the virtual object moves along the movement direction in the target state and performs the shoulder-fire operation through the virtual prop.

In a possible implementation, the game picture further has a shoulder-fire control displayed therein. The shoulder-fire control is configured to trigger a shoulder-fire function, the shooting function includes the shoulder-fire function, and a shooting operation corresponding to the shoulder-fire function includes the shoulder-fire operation.

The apparatus further includes:
a trigger module, configured to obtain the whole-body animation of the virtual object in response to a long-press operation for the shoulder-fire control and an end of the long-press operation, the whole-body animation being an animation in which the virtual object performs the shoulder-fire operation through the virtual prop when being in the target state.

In a possible implementation, the trigger module is configured to obtain a charging animation in response to a long-press operation for the shoulder-fire control, the charging animation is an animation in which charging is performed before the virtual object performs the shoulder-fire operation; display a charging animation; and obtain the whole-body animation in response to an end of the long-press operation.

In a possible implementation, the display module 2001 is further configured to display a charging progress bar in response to the long-press operation for the shoulder-fire control. The charging progress bar indicates a charged value of the virtual object and a chargeable value of the virtual object. The charged value of the virtual object is in direct proportion to a duration of the long-press operation. The charged value of the virtual object and the chargeable value of the virtual object are displayed in different manners in the charging progress bar.

In a possible implementation, the obtaining module 2002 is configured to: generate a second animation obtaining request in response to the long-press operation for the shoulder-fire control, the second animation obtaining request including an object identifier of the virtual object, a prop identifier of the virtual prop, and a target state; transmit the second animation obtaining request to a server; and receive the charging animation returned by the server based on the second animation obtaining request.

In a possible implementation, the apparatus further includes:
a determining module, configured to: determine a movement distance for a direction control in response to the trigger operation for the direction control; and determine a target location based on the movement direction, the movement distance, and a location of the virtual object in the virtual environment when triggering the direction control, a distance between the target location and the location of the virtual object in the virtual environment when triggering the direction control being the movement distance, and the target location being in a movement direction of the location of the virtual object in the virtual environment when triggering the direction control; and
a display module 2001, configured to display the whole-body animation at the target location.

In a possible implementation, the game picture further has a shooting control of the shooting function displayed therein, the shooting function includes a hip-fire function or a shoulder-fire function, the whole-body animation includes a first whole-body animation or a second whole-body animation, a shooting operation corresponding to the hip-fire function includes a hip-fire operation, a shooting operation corresponding to the shoulder-fire function includes a shoulder-fire operation, the first whole-body animation is an animation in which the virtual object performs the hip-fire operation through the virtual prop when being in the target state, and the second whole-body animation is an animation in which the virtual object performs the shoulder-fire operation through the virtual prop when being in the target state.

The obtaining module 2002 is configured to obtain a first whole-body animation in response to a short-press operation for the shooting control; or obtain a second whole-body animation in response to a long-press operation for the shooting control.

When the shooting function is triggered, the foregoing apparatus obtains the whole-body animation of the virtual object when the virtual object is in the target state and performs the shooting operation corresponding to the shooting function through the virtual prop, and then the obtained whole-body animation is displayed. The whole-body animation of the virtual object is obtained when the virtual object performs the shooting operation through the virtual prop, so that a subsequent animation display process is more coherent, and a shooting effect of the shooting operation performed by the virtual object through the virtual prop is better, thereby increasing the usage rate of the shooting function of the virtual object, and increasing an interaction rate of a game.

When the apparatus provided above implements the functions thereof, only division of the foregoing functional modules is used as an example for description. In practical application, the foregoing functions may be completed by different functional modules as required. To be specific, an internal structure of a device is divided into different functional modules to complete all or part of the functions described above. In addition, the apparatus provided in the foregoing embodiment belongs to the same idea as the method embodiment. For a specific implementation process thereof, reference is made to the method embodiment. Details are not described herein again.

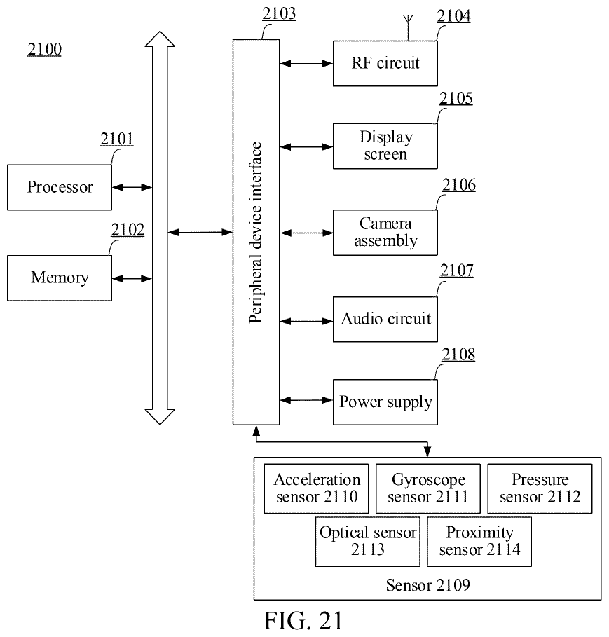

FIG. 21 is a structural block diagram of a terminal device 2100 according to an exemplary embodiment of this application. The terminal device 2100 may be any electronic device product that may perform human-computer interaction with a user in one or more manners such as a keyboard, a touch pad, a remote control, voice interaction, or a handwriting device, for example, a personal computer (PC), a mobile phone, a smart phone, a personal digital assistant (PDA), a wearable device, a pocket PC (PPC), a tablet computer, a smart car infotainment system, a smart television, a smart speaker, or a smart watch.

Generally, the terminal device 2100 includes a processor 2101 and a memory 2102.

The processor 2101 may include one or more processing cores, for example, a 4-core processor or an 8-core processor. The processor 2101 may be implemented in at least one of the following hardware forms: a digital signal processor (DSP), a field-programmable gate array (FPGA), and a programmable logic array (PLA). The processor 2101 may alternatively include a main processor and a coprocessor. The main processor is a processor configured to process data in an awake state, and is also referred to as a central processing unit (CPU). The coprocessor is a low power processor configured to process data in a standby state. In some embodiments, the processor 2101 may be integrated with a graphics processing unit (GPU). The GPU is configured to render and draw content that needs to be displayed on a display screen. In some embodiments, the processor 2101 may further include an artificial intelligence (AI) processor. The AI processor is configured to perform computing operations related to machine learning.

The memory 2102 may include one or more computer-readable storage media. The computer-readable storage media may be non-transient. The memory 2102 may further include a high-speed random access memory (RAM) and a nonvolatile memory, for example, one or more disk storage devices or flash storage devices. In some embodiments, the non-transitory computer-readable storage medium in the memory 2102 is configured to store at least one instruction. The at least one instruction is configured for being executed by the processor 2101 to implement the animation display method provided in the method embodiment of this application.

In some embodiments, the terminal device 2100 may further include a peripheral device interface 2103 and at least one peripheral device. The processor 2101, the memory 2102, and the peripheral device interface 2103 may be connected through a bus or a signal line. Each peripheral device may be connected to the peripheral device interface 2103 through a bus, a signal line, or a circuit board. Specifically, the peripheral device includes at least one of a radio frequency (RF) circuit 2104, a display screen 2105, a camera assembly 2106, an audio circuit 2107, and a power supply 2108.

The peripheral device interface 2103 may be configured to connect the at least one peripheral device related to input/output (I/O) to the processor 2101 and the memory 2102. In some embodiments, the processor 2101, the memory 2102, and the peripheral device interface 2103 are integrated on the same chip or the same circuit board. In some other embodiments, any one or two of the processor 2101, the memory 2102, and the peripheral device interface 2103 may be implemented on a separate chip or a separate circuit board, which is not limited in this embodiment.

The RF circuit 2104 is configured to receive and transmit an RF signal that is also referred to as an electromagnetic signal. The RF circuit 2104 communicates with a communication network and another communication device through the electromagnetic signal. The RF circuit 2104 converts an electrical signal into an electromagnetic signal for transmission, or converts a received electromagnetic signal into an electrical signal. In some embodiments, the RF circuit 2104 includes an antenna system, an RF transceiver, one or more amplifiers, a tuner, an oscillator, a DSP, a codec chipset, a subscriber identity module card, and the like.

The display screen 2105 is configured to display a user interface (UI). The UI may include a graph, texts, an icon, a video, and any combination thereof. When the display screen 2105 is a touch display screen, the display screen 2105 further has the capability of collecting a touch signal on or above a surface of the display screen 2105. The touch signal may be inputted to the processor 2101 as a control signal for processing. In this case, the display screen 2105 may be further configured to provide a virtual button and/or a virtual keyboard, which are/is also referred to as a soft button and/or a soft keyboard.

The camera assembly 2106 is configured to capture an image or a video. In some embodiments, the camera assembly 2106 includes a front camera and a rear camera. Generally, the front camera is arranged on a front panel of the terminal device 2100, and the rear camera is arranged on a back side of the terminal device 2100.

The audio circuit 2107 may include a microphone and a speaker. The microphone is configured to collect a sound wave of a user and an environment, and convert the sound wave into an electrical signal and input the electrical signal to the processor 2101 for processing, or input the electrical signal to the RF circuit 2104 to achieve voice communication. For the purpose of stereo collection or noise reduction, a plurality of microphones may be respectively arranged at different parts of the terminal device 2100. The microphone may be further an array microphone or an omni-directional acquisition microphone. The speaker is configured to convert the electrical signals from the processor 2101 or the RF circuit 2104 into sound waves.

The power supply 2108 is configured to supply power to components in the terminal device 2100. The power supply 2108 may be an alternating current power supply, a direct current power supply, a disposable battery, or a rechargeable battery. When the power supply 2108 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some embodiments, the terminal device 2100 further includes one or more sensors 2109. The one or more sensors 2109 include but are not limited to an acceleration sensor 2110, a gyroscope sensor 2111, a pressure sensor 2112, an optical sensor 2113, and a proximity sensor 2114.

The acceleration sensor 2110 may detect a magnitude of acceleration on three coordinate axes of a coordinate system established with the terminal device 2100. The gyroscope sensor 2111 may detect a body direction and a rotation angle of the terminal device 2100. The pressure sensor 2112 may be arranged at a side frame of the terminal device 2100 and/or a lower layer of the display screen 2105. The optical sensor 2113 is configured to collect ambient light intensity. The proximity sensor 2114, also referred to as a distance sensor, is usually arranged on the front panel of the terminal device 2100. The proximity sensor 2114 is configured to collect a distance between the user and a front side of the terminal device 2100.

A person skilled in the art may understand that the structure shown in FIG. 21 does not constitute a limitation on the terminal device 2100, and may include more or fewer components than those shown in the figure, or some merged components, or different component arrangements.

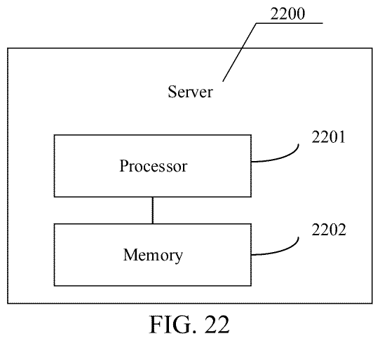

FIG. 22 is a schematic structural diagram of a server according to an embodiment of this application. A server 2200 may vary considerably in configuration or performance, and may include one or more CPUs 2201 and one or more memories 2202. The one or more memories 2202 have at least one program code stored therein, the at least one program code being loaded and executed by the one or more CPUs 2201 to implement the animation display method provided in the foregoing method embodiments. Certainly, the server 2200 may further have components such as a wired or wireless network interface, a keyboard, and an I/O interface for input and output. The server 2200 may further include another component configured to implement a device function. Details are not described herein.

In an exemplary embodiment, a computer-readable storage medium is further provided, the storage medium having at least one program code stored therein, the at least one program code being loaded and executed by a processor, to cause a computer to implement any one of the foregoing animation display methods.

In some embodiments, the foregoing computer-readable storage medium may be a read-only memory (ROM), a RAM, a compact disc ROM (CD-ROM), a magnetic tape, a floppy disk, an optical data storage device, or the like.

In an exemplary embodiment, a computer program or a computer program product is further provided, the computer program or the computer program product having at least one computer instruction stored therein, the at least one computer instruction being loaded and executed by a processor, to cause a computer to implement any one of the foregoing animation display methods.

Information (including but not limited to user device information, user personal information, and the like), data (including but not limited to data for analysis, stored data, displayed data, and the like), and signals involved in this application are all authorized by users or fully authorized by all parties, and collection, use, and processing of relevant data need to comply with relevant laws, regulations, and standards of relevant countries and regions. For example, the object identifier, the prop identifier, and some information involved in this application are all obtained with full authorization.

A term “a plurality of” mentioned herein means two or more than two. A term “and/or” means an association relationship for describing associated objects and represents that three relationships may exist. For example, A and/or B may represent the following three cases: only A exists, both A and B exist, and only B exists. The character “/” generally indicates an “or” relationship between a preceding associated object and a succeeding associated object.

The serial numbers of the foregoing embodiments of this application are merely for description, and do not represent the preference of the embodiments.

The foregoing descriptions are merely exemplary embodiments of this application, and are not intended to limit this application. Any modification, equivalent replacement, or improvement made within the spirit and principle of this application falls within the protection scope of this application.

What is claimed is:

1. An animation display method, performed by a computer device, comprising:
displaying a game picture, the game picture including a virtual object located in a virtual environment, the virtual object holding a virtual prop, the virtual object being in a target state, and the target state being one of a stationary state, a running state, or a walking state;
obtaining an animation of the virtual object in response to a trigger operation of a shooting function, the animation being an animation in which the virtual object performs a shooting operation through the virtual prop when being in the target state; and
displaying the animation.

2. The method according to claim 1, wherein obtaining the animation includes:
obtaining the animation based on a quantity of times the shooting function is triggered, in the animation, the virtual object performing the shooting operation through the virtual prop when the virtual object is in the target state and the shooting function is triggered for the quantity of times.

3. The method according to claim 1, wherein:
the game picture has a direction control; and
obtaining the animation in response to the trigger operation of the shooting function includes:
obtaining the animation based on a movement direction for the direction control in response to the trigger operation of the shooting function and a trigger operation for the direction control, in the animation, the virtual object moving along the movement direction in the target state and performs the shooting operation through the virtual prop.

4. The method according to claim 3, further comprising:
determining a movement distance for the direction control in response to the trigger operation of the shooting function and the trigger operation for the direction control;
based on the movement direction, the movement distance, and a first location, determining a second location, the first location being a location of the virtual object in the virtual environment when the direction control is triggered, the second location being in the movement direction of the first location, a distance between the second location and the first location being the movement distance, and the animation indicating that the virtual object moves toward the second location when performing the shooting operation; and
after displaying the animation, displaying the virtual object at the second location in response to an end of the animation.

5. The method according to claim 4, wherein determining the movement distance includes:
determining a product of a movement speed of the virtual object and a duration of the animation as the movement distance.

6. The method according to claim 1, wherein obtaining the animation includes:
generating an animation obtaining request including an object identifier of the virtual object, a prop identifier of the virtual prop, the target state, and target information, the target information indicating the shooting function;
transmitting the animation obtaining request to a server; and
receiving the animation returned by the server based on the animation obtaining request.

7. The method according to claim 6, wherein:
the shooting function includes a hip-fire function, the shooting operation corresponding to the shooting function includes a hip-fire operation, and the target information indicates the hip-fire function; and
generating the animation obtaining request in response to the trigger operation of the shooting function includes:
determining, in response to a trigger operation of the hip-fire function, a quantity of times the hip-fire function is triggered; and
generating the animation obtaining request based on the quantity of times the hip-fire function is triggered, the animation obtaining request further including the quantity of times the hip-fire function is triggered, and in the animation, the virtual object performing the hip-fire operation through the virtual prop when the virtual object is in the target state and the hip-fire function is triggered for the quantity of times.

8. The method according to claim 6, wherein:
the shooting function includes a shoulder-fire function, the shooting operation corresponding to the shooting function includes a shoulder-fire operation, the target information indicates the shoulder-fire function, and the game picture has a direction control; and
generating the animation obtaining request in response to the trigger operation of the shooting function includes:
determining a movement direction for the direction control in response to a trigger operation of the shoulder-fire function and a trigger operation for the direction control; and
generating the animation obtaining request based on the movement direction, the animation obtaining request further including the movement direction, and in the animation, the virtual object moving along the movement direction in the target state and performs the shoulder-fire operation through the virtual prop.

9. The method according to claim 1, wherein:
the game picture has a shoulder-fire control configured to trigger a shoulder-fire function, the shooting function includes the shoulder-fire function, and the shooting operation corresponding to the shoulder-fire function includes a shoulder-fire operation; and
obtaining the animation of the virtual object in response to the trigger operation of the shooting function includes:
obtaining the animation of the virtual object in response to a long-press operation for the shoulder-fire control and an end of the long-press operation, in the animation, the virtual object performing the shoulder-fire operation through the virtual prop when being in the target state.

10. The method according to claim 9, wherein obtaining the animation of the virtual object in response to the long-press operation for the shoulder-fire control and the end of the long-press operation includes:
obtaining a charging animation in response to the long-press operation for the shoulder-fire control, the charging animation being an animation in which the virtual object performs charging before performing the shoulder-fire operation;
displaying the charging animation; and
obtaining the animation in response to the end of the long-press operation.

11. The method according to claim 10, further comprising:
displaying a charging progress bar in response to the long-press operation for the shoulder-fire control, the charging progress bar indicating a charged value of the virtual object and a chargeable value of the virtual object, and the charged value of the virtual object being in direct proportion to a duration of the long-press operation.

12. The method according to claim 10, wherein obtaining the charging animation includes:
generating an animation obtaining request including an object identifier of the virtual object, a prop identifier of the virtual prop, and the target state;
transmitting the animation obtaining request to a server; and
receiving the charging animation returned by the server based on the animation obtaining request.

13. The method according to claim 1, wherein:
the game picture has a shooting control of the shooting function, the shooting function includes a hip-fire function or a shoulder-fire function, the animation includes a first animation or a second animation, a shooting operation corresponding to the hip-fire function includes a hip-fire operation, a shooting operation corresponding to the shoulder-fire function includes a shoulder-fire operation, in the first animation, the virtual object performs the hip-fire operation through the virtual prop when being in the target state, and in the second animation, the virtual object performs the shoulder-fire operation through the virtual prop when being in the target state; and
obtaining the animation of the virtual object in response to the trigger operation of the shooting function includes:
obtaining the first animation in response to a short-press operation for the shooting control; or
obtaining the second animation in response to a long-press operation for the shooting control.

14. A computer device comprising:
a processor; and
a memory storing at least one program code that, when executed by the processor, causes the computer device to:
display a game picture, the game picture including a virtual object located in a virtual environment, the virtual object holding a virtual prop, the virtual object being in a target state, and the target state being one of a stationary state, a running state, or a walking state;
obtain an animation of the virtual object in response to a trigger operation of a shooting function, in the animation, the virtual object performing a shooting operation through the virtual prop when being in the target state; and
display the animation.

15. The computer device according to claim 14, wherein the at least one program code, when executed by the processor, further causes the computer device to, when obtaining the animation:
obtain the animation based on a quantity of times the shooting function is triggered, in the animation, the virtual object performing the shooting operation through the virtual prop when the virtual object is in the target state and the shooting function is triggered for the quantity of times.

16. The computer device according to claim 14, wherein:
the game picture has a direction control; and
the at least one program code, when executed by the processor, further causes the computer device to, when obtaining the animation in response to the trigger operation of the shooting function:
obtain the animation based on a movement direction for the direction control in response to the trigger operation of the shooting function and a trigger operation for the direction control, in the animation, the virtual object moves along the movement direction in the target state and performs the shooting operation through the virtual prop.

17. The computer device according to claim 16, wherein the at least one program code, when executed by the processor, further causes the computer device to:
determine a movement distance for the direction control in response to the trigger operation of the shooting function and the trigger operation for the direction control;
based on the movement direction, the movement distance, and a first location, determine a second location, the first location being a location of the virtual object in the virtual environment when the direction control is triggered, the second location being in the movement direction of the first location, a distance between the second location and the first location being the movement distance, and the animation indicating that the virtual object moves toward the second location when performing the shooting operation; and
after displaying the animation, display the virtual object at the second location in response to an end of the animation.

18. The computer device according to claim 17, wherein the at least one program code, when executed by the processor, further causes the computer device to, when determining the movement distance:
determine a product of a movement speed of the virtual object and a duration of the animation as the movement distance.

19. The computer device according to claim 14, wherein the at least one program code, when executed by the processor, further causes the computer device to, when obtaining the animation:
generate an animation obtaining request including an object identifier of the virtual object, a prop identifier of the virtual prop, the target state, and target information, the target information indicating the shooting function;
transmit the animation obtaining request to a server; and
receive the animation returned by the server based on the animation obtaining request.

20. Anon-transitory computer-readable storage medium storing at least one program code that, when executed by a processor, causes a computer including the processor to:
display a game picture, the game picture including a virtual object located in a virtual environment, the virtual object holding a virtual prop, the virtual object being in a target state, and the target state being one of a stationary state, a running state, or a walking state;
obtain an animation of the virtual object in response to a trigger operation of a shooting function, in the animation, the virtual object performs a shooting operation through the virtual prop when being in the target state; and
display the animation.
